(19) United States
(12) Patent Application Publication
(10) Pub. No.: US 2013/0265303 A1
(43) Pub. Date: Oct. 10, 2013

(54) MOSAIC IMAGE PROCESSING APPARATUS USING THREE-DIMENSIONAL INFORMATION, AND PROGRAM

(71) Applicants: Junko Fujimaru, Tokyo (JP); Hiroshi Arimura, Fukuoka (JP); Satoshi Machida, Tokyo (JP)

(72) Inventors: Junko Fujimaru, Tokyo (JP); Hiroshi Arimura, Fukuoka (JP); Satoshi Machida, Tokyo (JP)

(73) Assignee: PITMEDIA MARKETINGS INCORPORATED, Tokyo (JP)

(21) Appl. No.: 13/994,561

(22) PCT Filed: Jan. 17, 2011
(86) PCT No.: PCT/JP2011/050673

§ 371 Date: Jun. 14, 2013

(30) Foreign Application Priority Data
Dec. 16, 2010 (JP) 2010-280937

(51) Int. Cl. G06T 15/04

(52) U.S. Cl. CPC G06T 15/04
USPC 345/420

(57) ABSTRACT

Realized is a 3D mosaic image generating technique enabling mapping of a material image with any polygon. Texture images are allocated to the polygons resulting from division on the basis of the input polygon number. The average density value of each base color of texture image portions is calculated as a target density value. The polygon in which one material image will be disposed is decided without reliance on the color density of the texture image, and the average density value of each base color within the material image is calculated. Each base-color density distribution rate for material images is maintained and the material images are color corrected so that the base-color average density values within material images become the target density values of the base colors of texture image portions within polygons.

### TECHNICAL FIELD

The present invention relates to a mosaic image generating technology using three-dimensional information with respect to a plurality of material images with its usage count that varies in time-series.

### BACKGROUND ART

A photo mosaic technology is known as a technique of generating an image of a single piece of large portrait or scene, etc by arranging a plurality of small images (original material images of photos etc) in matrix.

A general process in the conventional photo mosaic technology is that the photos (original material images) exhibiting suitable colorations are manually laid out through visual observation on a cell-by-cell basis in a way that presumes the colorations of the portrait or the scene in a completed state.

In this connection, the present applicant proposed a mosaic image generating technology in Japanese Patent Application Laid-Open Publication No. 2009-171158 (Patent document 1).

According to the technology described in Patent document 1 submitted by the present applicant, automatic generation of the mosaic image is realized without depending on an manual operation based on visual observation by eliminating a restraint on a material image corresponding to a target image, setting average density values of basic colors of the target image divided into a plurality of blocks as target density values, and performing color correction so that the average density value of each of the basic colors in the material image becomes the target density value of each of the basic colors in the block while retaining a density value distribution ratio of the material image in order to improve visual recognizability of the target image and the material image.

### PATENT DOCUMENT

[Patent document 1] Japanese Patent Application Laid-Open Publication No. 2009-171158

### SUMMARY OF THE INVENTION

### Problems to be Solved by the Invention

By the way, every prior art is based on an assumption that the image (target image) to be completed is formed of plane information such as a poster, i.e., two-dimensional information.

The present applicant, as a result of further studying the mosaic image technology over and over again, found out that a display promotion exhibiting high flexibility can be attained if capable of performing the mosaic image processing with a three-dimensional image being set as a target image.

It is a technical object of the present invention, which was devised in view of such a point, to propose a technology capable of generating and displaying the mosaic image with the three-dimensional image being set as the target image.

### Means for Solving the Problems

The present invention adopts the following expedients for solving the problems described above.

According to claim 1 of the present invention, a three-dimensional mosaic image display apparatus to generate and display a three-dimensional mosaic image by use of a plurality of material images, includes: a polygon count determining unit to determine a polygon count for divisions on the basis of an inputted material image count; a 3D modeling data generating unit to generate 3D modeling data divided by the determined polygon count; a 3D original image generating unit to allocate a texture image to the respective polygons and to calculate, as a target density value, an average density value of each of basic colors of the texture image region of each of the polygons divided by the dividing unit; a material image converting unit to determine the polygon in which one of the plurality of material images should be disposed without depending on a color density of the texture image; an average density value calculating unit to calculate the average density value of each of the basic colors within the material image; a color correction unit to correct colors of the material images so that the average density value of each of the basic colors within the material image becomes the target density value of each of the basic colors of the texture image region in the polygon while retaining a density value distribution ratio of each of the basic colors of the material images; a polygon generating unit to lay out the material images undergoing the color correction by the color correction unit over the polygons; and a 3D mosaic image generating unit to map the texture image to the generated 3D modeling data.

According to this three-dimensional mosaic image display apparatus, the material images can be automatically laid out irrespective of color densities of the texture image allocated to the polygons, and it is therefore feasible to generate and display the three-dimensional mosaic image that could not be attained so far by an manual operation based on visual observation.

According to claim 2, of the present invention, in the three-dimensional mosaic image display apparatus according to claim 1, the 3D modeling data generating unit can set, as an initial value, the polygon count of the polygons configuring the three-dimensional mosaic image to be completed. According to this three-dimensional mosaic image display apparatus, it is possible to previously determine the material image count by setting the polygon count of the three-dimensional mosaic image to be completed and to realize an advertisement promotion flexible to the number of participants.

According to claim 3 of the present invention, in the three-dimensional mosaic image display apparatus according to claim 1, the material image converting unit executes, when laying out the material images over the polygons, a process of discarding the material image area excluded by the line segments for defining the regular polygons. According to this three-dimensional mosaic image display apparatus, the material images can be displayed in a much larger area by performing divisions into the polygons taking regular polygonal shapes capable of ensuring a maximum area.

### Effects of the Invention

According to the present invention, it is feasible to perform the mosaic image processing with the three-dimensional image being set as the target image and to attain the display promotion exhibiting the high flexibility.

### BRIEF DESCRIPTION OF THE DRAWINGS

FIG. 1A view illustrating how an electronic plane image is configured by pixels having color information.

FIG. 2 A view illustrating a three-dimensional image configured by laying out plane information in space coordinates.

FIG. 3 A view illustrating how the color information is allocated to respective pieces of plane information by mapping a texture image having the color information.

FIG. 4 A view depicting that the material images are mapped to the respective pieces of plane information.

FIG. 5 A view illustrating a process of recording each of three-dimensional objects obtained by a process of reducing the plane information of the three-dimensional image.

FIG. 6 A view illustrating that each piece of plane information is configured by three or more apexes.

FIG. 7 A view illustrating a process of cutting out the material images in accordance with a shape of the plane information.

FIG. 8 A view illustrating that the corresponding material image is transformed likewise in accordance with transformation of the plane information.

FIG. 9 A view illustrating that the material image undergoes image processing according to the color information allocated to the plane information through the texture image.

FIG. 10 A function block diagram illustrating a conceptual functional configuration of a three-dimensional mosaic image generating apparatus.

### BEST MODE OF CARRYING OUT THE INVENTION

A best embodiment of the present invention will hereinafter be described by use of drawings.

FIG. 1 illustrates that a plane image 1 is formed by arraying individual pixels 2 each having color information in matrix with the aid of a computer.

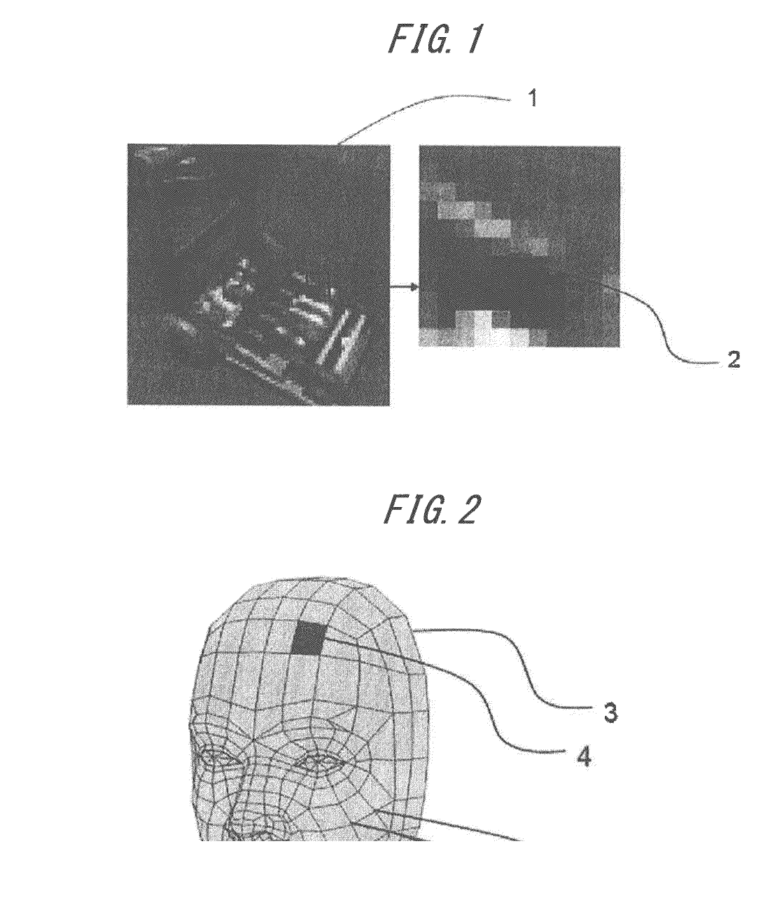

On the other hand, FIG. 2 is an explanatory illustration of a case generating a three-dimensional (3D) image 3 by use of an information processing apparatus (computer). To be specific, the 3D image 3 is expressed such that plane patterns called polygons 4 defined by line segments connecting three or more apexes are joined in the form of sharing the line segments with each other to form a three-dimensional shape (3D modeling data), and this three-dimensional shape is disposed on space coordinates.

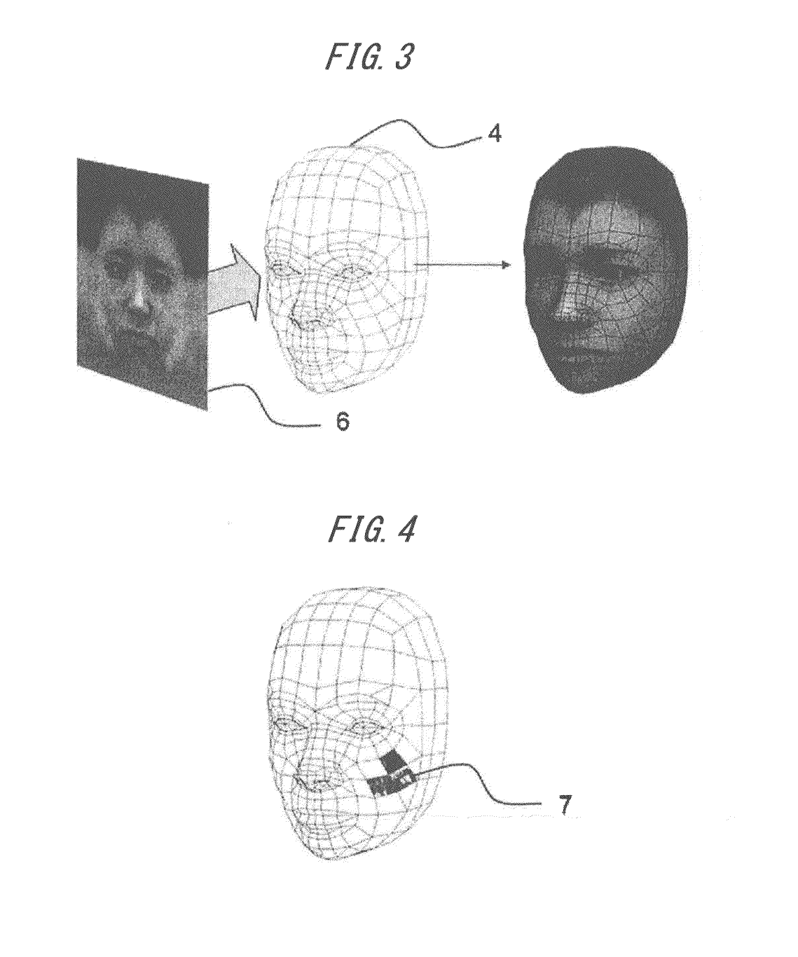

By the way, each of the polygons 4 configuring the 3D modeling data has no color information and is therefore required to have the color information as attributes in order to complete the 3D image. At this time, as illustrated in FIG. 3, an original image (a texture image 6) called a texture image is laid out in a way that matches with the respective polygons 4, thereby allocating pieces of color information to the polygons 4. Thus, an aggregation image of the polygons 4 attached with the texture image 6 is saved as the 3D image (completed version).

In the discussion made so far, it may be sufficient that the color information of each of the polygons 4 is determined by calculating an irradiating direction and luminance of the light on a per-polygon basis if the texture image 6 is a single image, however, material images disposed at the respective polygons have are different in terms of their brightness, saturation and hue, and therefore a problem is how these differences are modified with respect to the texture image.

According to the present invention, generation of a 3D mosaic image basically involves, as illustrated in FIG. 4, executing a process of establishing one-to-one correspondence of a single material image 7 to the single polygon 4 of the 3D modeling data. At this time, it is required to correct the material image 7 while keeping recognizability (e.g., in a way that makes an image of “Mona Lisa's Smile” recognizable) as a specified image of the texture image 6.

A general-purpose information processing, which is given as hardware for generating the 3D mosaic image, includes, with a central processing unit (CPU) and a main memory (MM) being centered, a hard disk (HD) device as a large-scale storage device, a keyboard (KBD) as an input device and a display (DISP) device as an output device that are connected via a bus (BUS). The hard disk (HD) device is preinstalled with a 3D mosaic image generating application program for getting the information processing apparatus to function together with an operating system (OS). This 3D mosaic image generating application program is read via the bus (BUS) and the main memory (MM) and sequentially executed by the central processing unit (CPU), thereby realizing functions of the present embodiment.

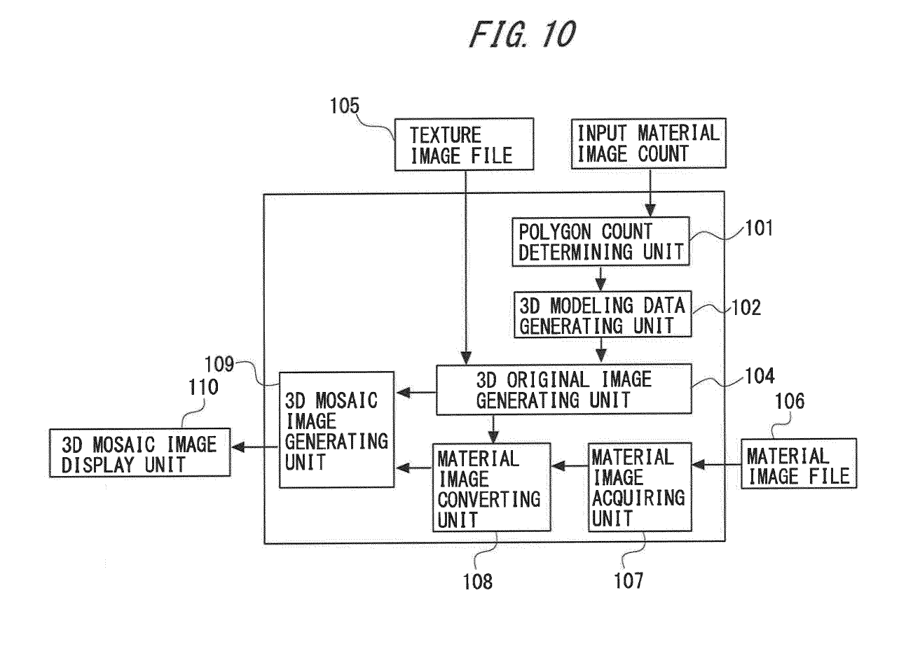

FIG. 10 is a block diagram illustrating these functions including a polygon count determining unit 101 that determines a polygon count (the number of polygons) of the 3D mosaic image which is completed by inputting a material image count. This polygon count can be arbitrarily set by an operator. For example, in the case of conducting a campaign to generate the 3D mosaic image of a face image of a media personality and if assuming 5,000 participants, it follows that 5,000 pieces of material image data are gathered, and hence the material image count is set to 5,000. The 3D modeling data based on the 5,000 pieces of segmented polygons are thereby generated. Further, an arbitrary material image count such as 1,000 through 10 can be also set (see FIG. 5). The thus-inputted material image count is stored in the main memory (MM) of the 3D mosaic image generating apparatus, and a 3D modeling data generating unit 102 generates 3D modeling data 8 corresponding to the material image count (see FIG. 5).

A 3D original image generating unit 103 inputs the 3D modeling data 8 generated as described above and a texture image file 105, and maps (pastes) the texture image file to the 3D modeling data 8.

Next, the 3D original image generating unit 104 calculates, by way of a characteristic process of the present invention, an average density value as a target density value of each of basic colors of the texture image region of each of the polygons allocated (mapped) to the 3D modeling data 8.

On the other hand, the respective pieces of material images 7 (e.g., face photo data of the individual participants) provided by the participants are inputted as a material image file 106 into the apparatus by a material image acquiring unit 107, and a material image converting unit 108 executes a process of converting the density values of respective component colors (RGB) that will be later on described on the basis of the target density value calculated by the 3D original image generating unit 104.

Herein, the material image file 106 may be stored on the hard disk etc beforehand and may also be what is received from a mobile phone etc with a built-in camera. Further, the image may be either color or monochrome. The following discussion will exemplify a case of making use of R (Red), G (Green) and B (Blue) as the color information (color space) possessed by image files 21, 28. As a matter of course, the present invention does not limit such a color component model, and hence a CMYK model (Cyan/Magenta/Yellow/Key tone model) etc may also be utilized.

The material image converting unit 108 fits the material images to the respective polygons and executes the image conversion corresponding to the color density values of the polygons. Thus, the material images fitted to the polygons undergo the conversion process based on the color density values of the respective polygons that are obtained from the texture image file, and hence these material images are not required to be manually fitted to the polygons of the texture image. In other words, it can be said that an advantage of the present invention lies in a point that the 3D mosaic image can be generated by allocating the material images to the arbitrary polygons without depending on the color density of the original texture image. This is realized by the following function units.

To start with, an average density calculation unit (unillustrated) of the material image converting unit 108 calculates an average density of each of the basic colors of the material images allocated to the respective polygons.

Herein, the “basic colors” connote colors for composing the colors of the pixels contained in the image area, in which the basic colors are, e.g., red, green and blue in the RGB color model and are cyan, magenta yellow and key tone in the CMYK color model. The “density value” connotes a ratio or variable (thick and thin) density information of each of the basic colors composing the colors of the pixels. Further, a “density value distribution ratio” connotes a usage ratio of the density values of the respective basic colors of the overall pixels within the image.

The average density value calculation unit calculates the average density value of each of the basic colors within the material image.

Specifically, to begin with, the material image 7 is converted into a grayscale image. The post-converting material image will hereinafter be referred to as a grayscale material image. The grayscale image is defined as an image expressed only by brightness information, in which the RGB values of the pixels are equalized.

The material image is thus converted into the grayscale image, whereby dispersions of the RGB values of the material image can be eliminated. It is therefore feasible to prevent occurrence of a color not existing so far in the material image due to the dispersions of the RGB values when a color correction unit (unillustrated) in the material image converting unit 108 corrects likewise the colors of the material image file, and, by extension, visual recognizability of the material image can be improved. Moreover, histograms of the grayscale material image are the same with respect to the RGB information. Hence, the conversion of the material image into the grayscale image enables a quantity of calculations to be reduced because of its being sufficient to perform a calculation process, taken in the next discussion, of the material image about only any one of RGB. Note that a variety of techniques such as a technique of taking a simple average or a weighted average of the RGB values are already known, and therefore an in-depth description of this technique of the conversion into the grayscale image is herein omitted.

The process by the average density calculation unit involves calculating a predetermined statistic value based on any one of the RGB basic colors contained in the material image with respect to the grayscale material image. The case of using the R-value as the basic color will hereinafter be described by way of an example.

A minimum R-value in the R-values of the overall pixels contained in the grayscale material image is extracted. Then, this minimum R-value is subtracted from the overall R-values of the material image. In other words, this implies that an R-value distribution is shifted in a decreasing direction of the density value so that the extracted minimum R-value becomes an allowable lowest density value (0 (zero)).

Next, in regard to the thus shift-converted R-histogram, there are calculated a lowest density value (equal to the allowable lowest density value), a highest density value, an average density value and a ratio between a density value of the lowest density value through the average density value and a density value of the average density value through the highest density value, respectively. The average density value is a value obtained by dividing a total of the R-values of the overall pixels in the converted histogram by a pixel count (the number of pixels). Hereafter, a ratio value in a direction smaller than the average density value is referred to as a dark density value, while a ratio value in a direction larger than the average density value is referred to as a bright density value.

The average density value calculation unit extracts e.g., “16” as the minimum R-value from the R-values of overall pixels. Then, “16” is subtracted from the R-values of the overall pixels on the basis of this extracted value. Calculated based on the thus-converted R-value distribution are statistic values such as the lowest density value (0), the highest density value (215), the average density value (93.60), the dark density value (0.44, 93.60) and the bright density value (0.56, 121.40), respectively. These calculated statistic values are hereafter processed as the statistic values of RGB.

The color correction unit performs a process of correcting the colors of the material image so that the average density value of each of the basic colors in the material image becomes the target density value of each of the basic colors of the texture image area within the polygon while retaining the density value distribution ratio of each of the basic colors of the material image.

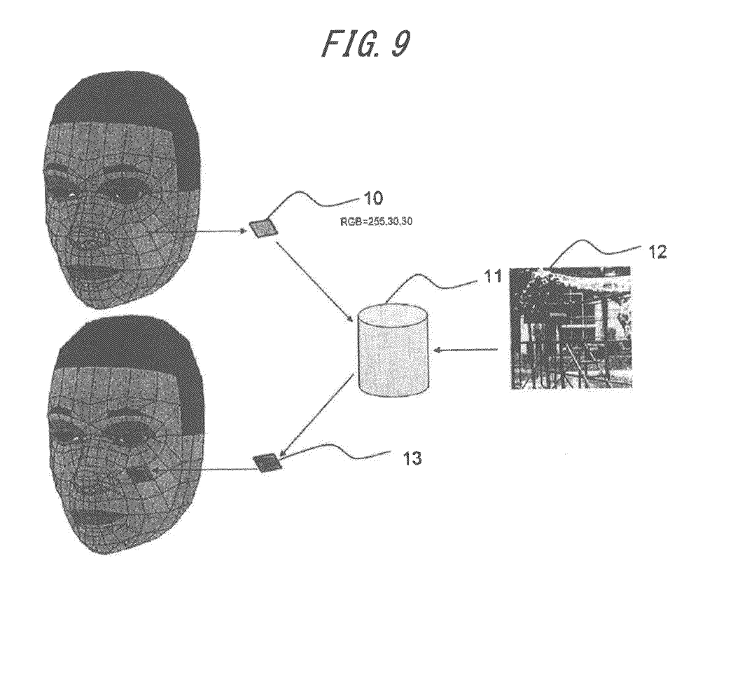

FIG. 9 illustrates a concept of this color correction. Even the same material image 12 becomes, through undergoing the color correction in the color correction unit, pieces of already-corrected material images 10, 13 different from each other and are then allocated to the polygons. The following is a description thereof.

The color correction unit acquires the respective statistic values pertaining to the grayscale material image and obtains polygon IDs specifying polygon positions in which the material image is laid out. Subsequently, the color correction unit acquires an R target value, a G target value and a B target value of the texture image area specified by the polygon IDs, respectively. Then, the color correction unit corrects the colors of the material image 7 so that the average density values of the material image become the R target value, the G target value and the B target value of the target block image.

To make a concrete description, in the case of supposing that the average density value of the material image 7 is calculated to be 93.60, the RGB target values of the polygon images over which the material image 7 should be laid out are determined such that the R target value is 165, the G target value is 105, and the B target value is 54. The color correction unit 106 corrects the overall R-values of the material image 7 so that the average density value (93.60) thereof becomes the R target value (165) of the block image. Similarly, a material image correction unit 48 corrects overall G-values of a material image 82 so that the average density value (93.60) thereof becomes the G target value (105) of the block image, and also corrects overall B-values so that the average density value (93.60) thereof becomes the B target value (54) of the block image.

Herein, when moving the average density value of the original material image to the target density value, there are a case in which the maximum density value of the original material image exceeds an allowable maximum density value and a case of not exceeding. When determining that the maximum density value of the original material image exceeds the allowable maximum density value, it may be sufficient that the color correction unit 106 reduces (compresses) a distribution width of the original material image so that the maximum density value becomes the allowable maximum density value in a state of fixing the average density value to the target density value.

Whereas when determining that the maximum density value of the original material image does not exceed the allowable maximum density value, the color correction unit compresses or expands the distribution width of the original material image so that the average density value becomes the target density value in a state of fixing the lowest density value to the allowable lowest density value. The distribution width is reduced if the original average density value is larger than the target density value but is enlarged whereas if the original average density value is smaller than the target density value.

Thus, the color correction unit executes processing to retain the color tones of the material image to the greatest possible degree for enhancing the visual recognizability of the material image while making the material image approximate to the color tones of the block image in order to enhance the visual recognizability of the whole mosaic image.

Next, a specific processing example of the color correction unit will be described.

The color correction unit, at first, determines whether or not each of values obtained by dividing, as given as below, the target density values by the dark density value (0.44) exceeds the allowable highest density value (255).

(R-value): R target density value (165)/dark density value (0.44)=375

(G-value): G target density value (105)/dark density value (0.44)=238.64

(B-value): B target density value (54)/dark density value (0.44)=122.73

The color correction unit 106, when determining that the calculated value exceeds the allowable highest density value, corrects the density value of each of the pixels of the original material image by use of the following (Mathematical Expression A). Note that the value “255” represents the allowable highest density value.

(Original Density Value−Lowest Density Value)×H+I (Mathematical Expression A)

H=(255−Target Value)/Bright Density Value

I=255−(Highest Density Value×H)

While on the other hand, the color correction unit 106, when determining that the calculated value does not exceed the allowable highest density value, corrects each of the density value of each of the pixels of the original material image by employing the following (Mathematical Expression B).

(Original Density Value−Lowest Density Value)×J (Mathematical Expression B)
J=Target Value/Dark Density Value

The overall R-values of the material image are corrected in the (Mathematical Expression A), and the overall G-values and the overall B-values thereof are corrected in the (Mathematical Expression B). To be specific, “H” of the R-value is 0.74 (=(255−165)/121.40), and “I” of the R-value is 95.90 (=255-(215*0.74)). The value “J” of the G-value is 1.12 (=105/93.60), and “J” of the B-value is 0.58 (=54/93.60). Thus, the material image correction unit 48 corrects the RGB colors of the material image.

The material image data thus undergoing the color correction in the color correction unit are mapped to the segmental regions of the respective polygons by the polygon generating unit, and the mapped data are displayed on an external display device via the 3D mosaic image generating unit 109.

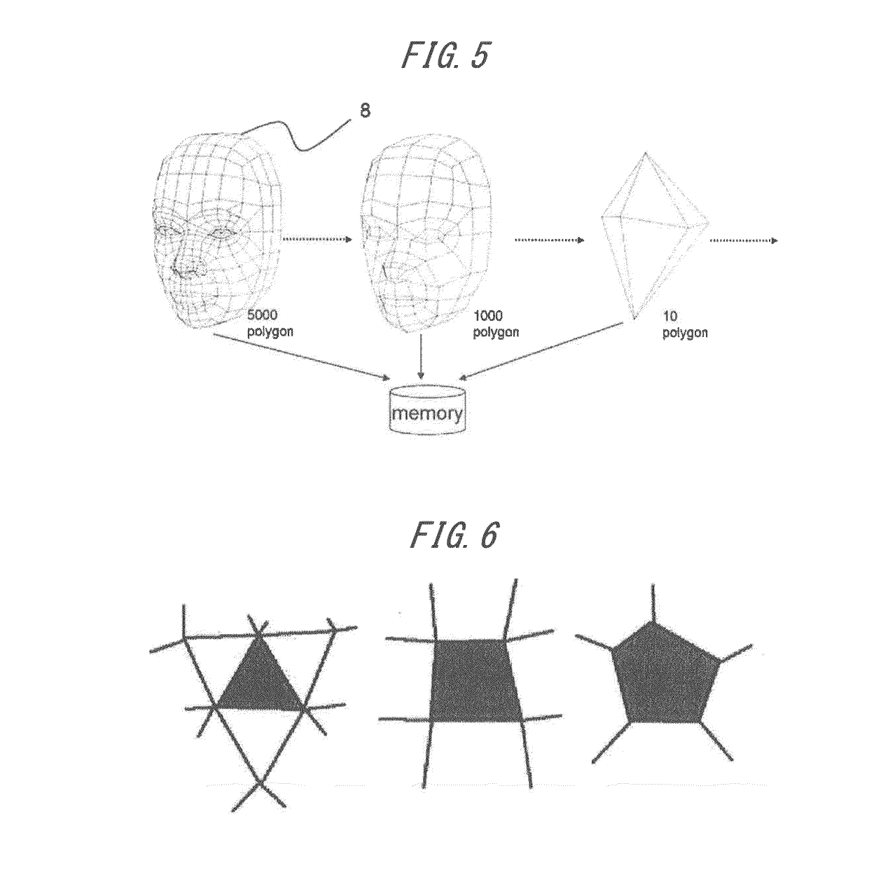

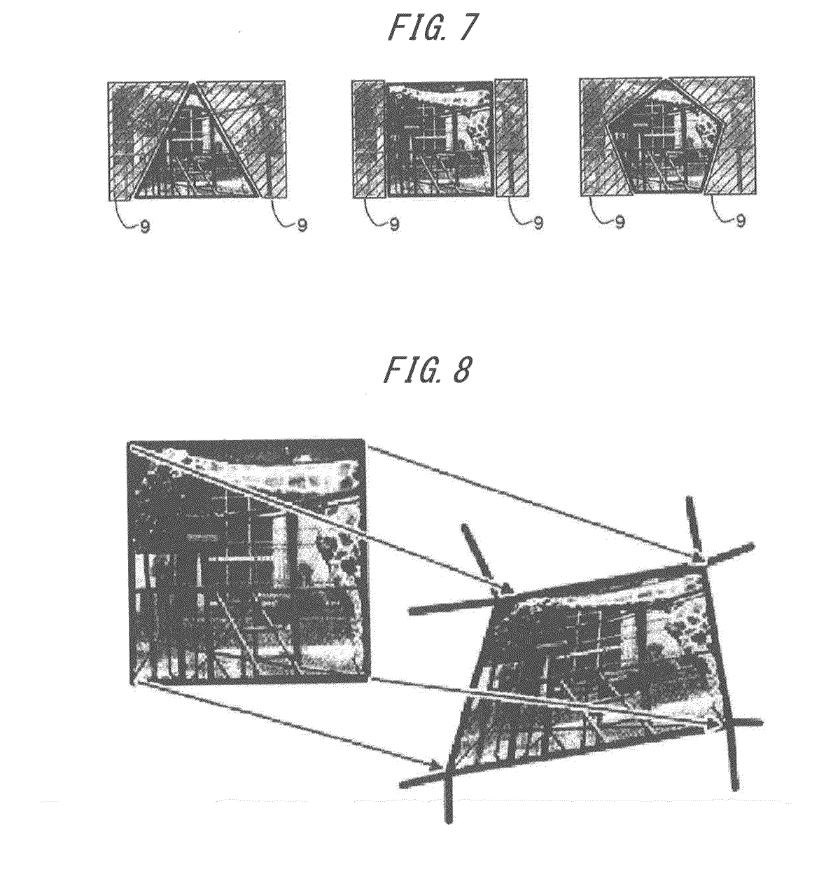

Note that, as illustrated in FIG. 6, the polygon is configured by a polygonal shape, while the material image data 7 is configured by a quadrangular shape, and hence, as depicted in FIG. 7, the image material area 9 excluded when mapped to the polygons may be discarded in the process of the 3D original image generating unit 104.

Further, even when the polygon is configured by the quadrangular shape, a trapezoidal shape, a parallelogram shape or an undefined quadrangular shape, the 3D original image generating unit 104 may conduct the image conversion as illustrated in FIG. 8.

### INDUSTRIAL APPLICABILITY

The present invention can be applied to a promotion for conducting a user participation type campaign by using the image information processing apparatus.

### DESCRIPTION OF THE REFERENCE NUMERALS AND SYMBOLS

1 plane image
2 pixel
3 3D image
4 polygon
6 texture image
7 material image
8 3D modeling data
9 image discarding area

1. A three-dimensional mosaic image display apparatus to generate and display a three-dimensional mosaic image by use of a plurality of material images, comprising:
a polygon count determining unit to determine a polygon count for divisions on the basis of an inputted material image count;
a 3D modeling data generating unit to generate 3D modeling data divided by the determined polygon count;
a 3D original image generating unit to allocate a texture image to the respective polygons and to calculate, as a target density value, an average density value of each of basic colors of the texture image region of each of the polygons divided by the dividing unit;
a material image converting unit to determine the polygon in which one of the plurality of material images should be disposed without depending on a color density of the texture image;
an average density value calculating unit to calculate the average density value of each of the basic colors within the material image;
a color correction unit to correct colors of the material images so that the average density value of each of the basic colors within the material image becomes the target density value of each of the basic colors of the texture image region in the polygon while retaining a density value distribution ratio of each of the basic colors of the material images;
a polygon generating unit to layout the material images undergoing the color correction by the color correction unit over the polygons; and
a 3D mosaic image generating unit to map the texture image to the generated 3D modeling data.

2. The three-dimensional mosaic image display apparatus according to claim 1, wherein the 3D modeling data generating unit can set, as an initial value, the polygon count of the polygons configuring the three-dimensional mosaic image to be completed.

3. The three-dimensional mosaic image display apparatus according to claim 1, wherein the material image converting unit executes, when laying out the material images over the polygons, a process of discarding the material image area excluded by the line segments for defining the regular polygons.
